(19) United States
(12) Patent Application Publication
(10) Pub. No.: US 2010/0316947 A1
(43) Pub. Date: Dec. 16, 2010

(54) METHOD FOR PRODUCING RESIN EMULSION

(75) Inventors: Hiroshi Mizuhata, Wakayama, (JP); Nobumichi Kamiyoshi, Wakayama (JP); Shinichi Sata, Wakayama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Chuo-ku, Tokyo (JP)

(21) Appl. No.: 12/525,834

(22) PCT Filed: Jan. 25, 2008
(86) PCT No.: PCT/JP2008/051034

§ 371 Date: Aug. 5, 2009

(30) Foreign Application Priority Data
Feb. 13, 2007 (JP) 2007-032444

(51) Int. Cl. G03G 9/087; C08L 67/00

(52) U.S. Cl. 430/109.4; 524/600; 430/137.14

(57) ABSTRACT

The present invention relates to a resin emulsion which has a good emulsification performance even when produced by using a crosslinked polyester resin having a good fusing ability and a good durability, and also is capable of producing a toner having an excellent heat-resistant storage property therefrom; and a process for producing the resin emulsion. The process for producing a resin emulsion according to the present invention, includes the steps of: (a) mixing a resin containing a polyester having a constitutional unit derived from at least one component selected from the group consisting of a trivalent or higher-valent alcohol component and a trivalent or higher-valent carboxylic acid component, an anionic surfactant, and a nonionic surfactant with each other at a temperature which is not lower than a temperature lower by 10° C. than a softening point of the resin, the nonionic surfactant being used in an amount of more than 1.0 part by weight and less than 5 parts by weight on the basis of 100 parts by weight of the resin; and (b) neutralizing the resulting mixture obtained in the step (a) with a basic compound in an aqueous medium at a temperature not higher than the softening point of the resin.

### TECHNICAL FIELD

The present invention relates to a process for producing a resin emulsion, and also relates to a resin emulsion, and a toner for electrophotography obtained by using the process and the resin emulsion.

### BACKGROUND ART

In the field of toners for electrophotography, it has been demanded to develop toners having a smaller particle size and an excellent fusing ability in view of achieving higher image qualities. Conventional processes for producing the toners include a melt-kneading and pulverization method, and a wet process such as an emulsification and aggregation method. In these methods, binder resins, for example, those composed mainly of a polyester, are used to obtain toner particles from the viewpoint of a good fusing ability thereof.

Conventionally, in some kinds of polyesters as the binder resin, a trivalent carboxylic acid such as trimellitic acid has been used as an acid monomer component thereof, in particular, from the viewpoints of a good fusing ability and a good durability of the resulting toner. For example, Patent Document 1 discloses a toner obtained by using a polyester resin containing an aromatic dicarboxylic acid component such as isophthalic acid and terephthalic acid, an aromatic tricarboxylic acid component such as trimellitic acid or an aliphatic dicarboxylic acid component such as dodecenylsuccinic acid as a constitutional unit thereof.

In addition, as the method for producing the toner having a small particle size, there has been proposed, for example, a method for producing a toner for electrophotography containing a binder resin and a colorant which process includes the step of forming the binder resin into fine particles having a volume-median particle size (D₅₀) of from 0.05 to 3 μm in an aqueous medium in the presence of a nonionic surfactant at a temperature ranging from a temperature lower by 10° C. than a cloud point of the nonionic surfactant to a temperature higher by 10° C. than the cloud point (for example, refer to Patent Document 2).

Patent Document 1: JP 6-19204A

Patent Document 2: JP 2006-106679A

### DISCLOSURE OF THE INVENTION

### Problem to be Solved by the Invention

However, in the above emulsification and aggregation method in which the crosslinked polyester resin obtained from the aromatic tricarboxylic acid such as trimellitic acid is used to produce a toner, it is not easy to prepare a resin emulsion containing fine resin particles by emulsification, and even if the resin is emulsified, the resin emulsified in the resin emulsion may have a relatively low molecular weight. As a result, the toner produced from such a resin emulsion tends to suffer from problems such as deteriorated fusing ability, in particular, poor high-temperature anti-offset property and poor heat-resistant storage property.

On the other hand, in the technique described in Patent Document 2, although the toner having a small particle size is obtained, it has been still required that the resulting toner is further improved in a heat-resistant storage property, etc.

In consequence, the present invention relates to a resin emulsion exhibiting a good emulsification performance even when produced by using a crosslinked polyester resin having a good fusing ability and a good durability, and also having an excellent heat-resistant storage property; a process for producing the resin emulsion; a toner for electrophotography obtained from the resin emulsion; and a process for producing the toner.

### Means for Solving Problem

Thus, the present invention relates to:

[1] A process for producing a resin emulsion, which includes the steps of:

(a) mixing a resin containing a polyester having a constitutional unit derived from at least one component selected from the group consisting of a trivalent or higher-valent alcohol component and a trivalent or higher-valent carboxylic acid component, an anionic surfactant, and a nonionic surfactant with each other at a temperature which is not lower than a temperature lower by 10° C. than a softening point of the resin, the nonionic surfactant being used in an amount of more than 1.0 part by weight and less than 5 parts by weight on the basis of 100 parts by weight of the resin; and

(b) neutralizing the resulting mixture obtained in the step (a) with a basic compound in an aqueous medium at a temperature not higher than the softening point of the resin.

[2] A resin emulsion produced by the process as defined in the above [1].

[3] A resin emulsion including a binder resin containing a polyester having a constitutional unit derived from at least one component selected from the group consisting of a trivalent or higher-valent alcohol component and a trivalent or higher-valent carboxylic acid component, a nonionic surfactant, and an anionic surfactant, wherein the binder resin is contained in the form of resin particles having a weight-average molecular weight of from 2×10⁴ to 1×10⁵ and containing a component having a molecular weight of not less than 1×10⁵ and not more than 1×10⁶ in an amount of from 2 to 15%, and a content of the nonionic surfactant in the resin emulsion is more than 1.0 part by weight and less than 5 parts by weight on the basis of 100 parts by weight of the binder resin.

[4] A resin emulsion produced by emulsifying a binder resin containing a polyester having a constitutional unit derived from at least one component selected from the group consisting of a trivalent or higher-valent alcohol component and a trivalent or higher-valent carboxylic acid component, in an aqueous medium in the presence of a nonionic surfactant and an anionic surfactant, wherein the binder resin is contained in the form of resin particles having a weight-average molecular weight of from 2×10⁴ to 1×10⁵ and containing a component having a molecular weight of not less than 1×10⁵ and not more than 1×10⁶ in an amount of from 2 to 15%, and a content of the nonionic surfactant in the resin emulsion is more than 1.0 part by weight and less than 5 parts by weight on the basis of 100 parts by weight of the binder resin.

[5] A process for producing a toner for electrophotography, including the steps of:
(1) producing a resin emulsion by the process as defined in the above [1]; and
(2) aggregating and coalescing emulsified resin particles contained in the resin emulsion obtained in the step (1).

[6] A toner for electrophotography produced by using the resin emulsion as defined in any one of the above [2] to [4].

[7] A toner for electrophotography produced by the process as defined in the above [5].

### Effect of the Invention

In accordance with the present invention, there are provided a resin emulsion which has a good emulsification performance even when produced by using a crosslinked polyester resin having a good fusing ability and a good durability, and also is capable of producing a toner having an excellent heat-resistant storage property therefrom; a process for producing the resin emulsion; a toner for electrophotography produced by using the resin emulsion; and a process for producing the toner.

### BEST MODE FOR CARRYING OUT THE INVENTION

### Process for Producing Resin Emulsion, and Resin Emulsion

The process for producing a resin emulsion according to the present invention includes the steps of (a) mixing a resin containing a polyester having a constitutional unit derived from at least one component selected from the group consisting of a trivalent or higher-valent alcohol component and a trivalent or higher-valent carboxylic acid component, an anionic surfactant, and a nonionic surfactant with each other at a temperature which is not lower than a temperature lower by 10° C. than a softening point of the resin (hereinafter referred to merely as a temperature calculated from “softening point of the resin −(minus) 10° C.”), the nonionic surfactant being used in an amount of more than 1.0 part by weight and less than 5 parts by weight on the basis of 100 parts by weight of the resin; and (b) neutralizing the resulting mixture obtained in the step (a) with a basic compound in an aqueous medium at a temperature not lower than the temperature calculated from “softening point of the resin −(minus) 10° C.”.

The resin, nonionic surfactant and anionic surfactant are mixed with each other at a temperature not lower than the temperature calculated from “softening point of the resin −(minus) 10° C.”, thereby enabling uniformly mixing the resin and the surfactants. When uniformly mixing these components, the substantial softening point of the resin can be lowered by action of the nonionic surfactant, and the anionic surfactant can be efficiently dispersed in the resin. As a result of these effects, it is possible to obtain finer emulsified particles even when using the crosslinked polyester.

One feature of the resin emulsion of the present invention resides in that the resin emulsion is obtained by emulsifying the resin in the presence of specific amounts of the nonionic surfactant and the anionic surfactant. In the case of the conventional resin emulsions, in order to emulsify the resin, it is necessary to use a considerably large amount of the nonionic surfactant, so that a large amount of the surfactant tends to remain in the resulting resin emulsion. In this case, if the resin emulsion is not fully washed upon production of a toner, a large amount of the surfactant also tends to remain in the resulting toner, thereby causing such a risk that the residual nonionic surfactant gives an adverse influence on a performance of the toner. On the other hand, according to the present invention, since the anionic surfactant is efficiently dispersed in the resin which is softened by action of the nonionic surfactant, it is considered that the resin can be readily emulsified even when the surfactants are used in a smaller amount than conventionally, thereby attaining such an effect that the amounts of the surfactants remaining in the resin emulsion, in particular, in the toner can be reduced.

### Polyester-Containing Binder Resin

The binder resin used in the present invention contains a polyester from the viewpoints of a good fusing ability and a good durability of the resulting toner. The content of the polyester in the binder resin is preferably 60% by weight or more, more preferably 70% by weight or more, even more preferably 80% by weight or more and further even more preferably substantially 100% by weight from the viewpoints of a good fusing ability and a good durability of the resulting toner.

Meanwhile, in the present invention, as the polyester, there may be used not only unmodified polyesters but also modified polyesters obtained by modifying polyesters to such an extent that the polyesters are substantially free from deterioration in inherent properties thereof. Examples of the modified polyesters include polyesters grafted or blocked with phenol, urethane, epoxy, etc., by the methods described, for example, in JP 11-133668A, JP 10-239903A and JP 8-20636A, and composite resins containing two or more kinds of resin units including a polyester unit.

Further, from the viewpoints of a good fusing ability and a good durability of the toner, the above binder resin may contain two kinds of polyesters which are different in softening point from each other in which one polyester (a) preferably has a softening point of not lower than 70° C. but lower than 115° C., and the other polyester (b) preferably has a softening point of not lower than 115 but not higher than 165° C.

The weight ratio of the polyester (a) to the polyester (b) (a/b) in the binder resin is preferably from 10/90 to 90/10.

Examples of resins other than the polyester which may be contained in the binder resin include known resins conventionally used for toners such as styrene-acryl resins, epoxy resins, polycarbonates and polyurethanes.

In the present invention, from the viewpoints of a good durability, a good fusing ability and a good gloss of the resulting toner, the polyester has a constitutional unit derived from a trivalent or higher-valent alcohol component and/or a trivalent or higher-valent carboxylic acid component.

The total content of the trivalent or higher-valent carboxylic acid monomer component and the trivalent or higher-valent alcohol monomer component in whole raw monomer components is preferably from 4 to 25 mol %, more preferably from 4.5 to 21 mol %, even more preferably from 5 to 17 mol % and further even more preferably from 5 to 13 mol % on the basis of the whole raw monomer components from the viewpoints of a good gloss, a good image density and a good durability of images printed. In the present invention, the constitutional unit derived from the trivalent or higher-valent carboxylic acid component and/or the trivalent or higher-valent alcohol component can be obtained by using a trivalent or higher-valent carboxylic acid monomer component and/or a trivalent or higher-valent alcohol monomer component as raw monomer components of the polyester. The content of the constitutional unit derived from the trivalent or higher-valent carboxylic acid monomer component and/or the trivalent or higher-valent alcohol monomer component in the polyester is the same as that of the trivalent or higher-valent carboxylic acid component and/or the trivalent or higher-valent alcohol component in the whole raw monomer components as described above. Meanwhile, in the case where two or more kinds of polyesters are used in combination with each other, the content of the trivalent or higher-valent carboxylic acid component and/or the trivalent or higher-valent alcohol component in the whole raw monomer components used for the two or more kinds of polyesters may fall within the above-specified range.

The trivalent or higher-valent carboxylic acid component and/or the trivalent or higher-valent alcohol component used in the present invention are not particularly limited, and preferably selected from those which function as a crosslinking agent when producing the polyester by reacting the alcohol component with the carboxylic acid component. Specific examples of the trivalent or higher-valent carboxylic acid component include trimellitic acid, pyromellitic acid, etc. and anhydrides of these acids or alkyl (C₁ to C₃) esters thereof. Specific examples of the trivalent or higher-valent alcohol component include glycerol, pentaerythritol, trimethylol propane, sorbitol, and alkylene (C₂ to C₄) oxide adducts (average molar number of addition of alkyleneoxides: 1 to 16) of these alcohols, etc. These trivalent or higher-valent carboxylic acid components and trivalent or higher-valent carboxylic acid components may be respectively used alone or in combination of any two or more thereof.

In the present invention, among these trivalent or higher-valent carboxylic acid components and trivalent or higher-valent alcohol components, from the viewpoints of well-controlled molecular weight of the binder resin contained in the resin particles and a good fusing ability of the resulting toner, preferred are a trivalent carboxylic acid component and a trivalent alcohol component. Among them, trimellitic acid is more preferred as the trivalent carboxylic acid component, and glycerol and trimethylol propane are more preferred as the trivalent alcohol component. Among these components, from the viewpoints of a good fusing ability and a good durability of the resulting toner, even more preferred is trimellitic acid.

The presence of the polycarboxylic acid such as trimellitic acid in the resin emulsion or the toner may be detected by a suitable analyzing method such as ¹H-NMR. More specifically, when trimellitic acid is present in the resin emulsion or the toner, the presence of trimellitic acid may be determined by observation of a peak in chemical shift ranging from 8.2 to 8.4 ppm when measured in a deuterated chloroform extract thereof.

The content of the trivalent or higher-valent carboxylic acid component in whole acid monomer components is preferably from 8 to 35 mol %. When the content of the trivalent or higher-valent carboxylic acid component is 8 mol % or more, the effect of adding the trivalent or higher-valent carboxylic acid component can be suitably exhibited so that a crosslinked resin having a desired softening point or a desired high-molecular weight moiety can be obtained. When the content of the trivalent or higher-valent carboxylic acid component is 35 mol % or less, occurrence of excessively high-density crosslinking can be prevented, so that the toner produced by using the resulting polyester can be inhibited from being deteriorated in low energy fusing ability. From the same viewpoints as described above, the content of the trivalent or higher-valent carboxylic acid component in whole acid monomer components is more preferably from 9 to 32 mol % and even more preferably from 10 to 30 mol %.

The content of the trivalent or higher-valent alcohol component in whole alcohol monomer components is preferably from 5 to 35 mol %. When the content of the trivalent or higher-valent alcohol component is 5 mol % or more, the effect of adding the trivalent or higher-valent alcohol component can be suitably exhibited, so that a crosslinked resin having a desired softening point and a desired high-molecular weight moiety can be obtained. When the content of the trivalent or higher-valent alcohol component is 35 mol % or less, occurrence of excessively high-density crosslinking can be prevented, so that the toner produced by using the resulting polyester can be inhibited from being deteriorated in low energy fusing ability. From the same viewpoints as described above, the content of the trivalent or higher-valent alcohol component in whole alcohol monomer components is more preferably from 6 to 32 mol % and even more preferably from 7 to 30 mol %.

The polyester used in the present invention has a constitutional unit derived from the trivalent or higher-valent alcohol component and/or the trivalent or higher-valent carboxylic acid component. From the viewpoints of well-controlled molecular weight of the polyester and a good fusing ability of the resulting toner, the polyester preferably has a constitutional unit derived from the trivalent alcohol component and/or the trivalent carboxylic acid component.

When the resin emulsion or the toner contains two or more kinds of polyesters, the content (mol %) of the constitutional unit derived from the trivalent or higher-valent alcohol component and/or the trivalent or higher-valent carboxylic acid component may be determined as a sum of the values respectively calculated by multiplying a content (mol %) of the constitutional unit in each polyester by a proportion of the polyester based on the whole polyesters.

As the other raw monomer components for the polyester, there may be usually used known divalent or higher-valent alcohol components and known acid components such as divalent or higher-valent carboxylic acids, carboxylic anhydrides and carboxylic esters.

Examples of the carboxylic acid component other than the trivalent or higher-valent carboxylic acid component include dicarboxylic acids such as phthalic acid, isophthalic acid, terephthalic acid, fumaric acid, maleic acid, adipic acid and succinic acid; succinic acids substituted with an alkyl group having 1 to 20 carbon atoms or an alkenyl group having 2 to 20 carbon atoms such as dodecenylsuccinic acid and octenylsuccinic acid; and anhydrides of these acids and alkyl (C₁ to C₃) esters thereof.

These carboxylic acid components may be used alone or in combination of any two or more thereof.

Examples of the alcohol component other than the trivalent or higher-valent alcohol component include alkylene (C₂ to C₃) oxide adducts (average molar number of addition: 1 to 16) of bisphenol A such as polyoxypropylene-2,2-bis(4-hydroxyphenyl)propane and polyoxyethylene-2,2-bis(4-hydroxyphenyl)propane, ethylene glycol, propylene glycol, butanediol, neopentyl glycol, hexanediol, and alkylene (C₂ to C₄) oxide adducts (average molar number of addition: 1 to 16) of these alcohols.

These alcohol components may be used alone or in combination of any two or more thereof.

The polyester may be produced, for example, by polycondensing the alcohol component and the carboxylic acid component in an inert gas atmosphere at a temperature of about 180 to 250° C. by using, if required, an esterification catalyst.

Examples of the esterification catalyst include tin compounds such as dibutyl tin oxide and tin dioctylate, and titanium compounds such as titanium diisopropylate bistriethanol aminate. The amount of the esterification catalyst used is preferably from 0.01 to 1 part by weight and more preferably from 0.1 to 0.6 part by weight on the basis of 100 parts by weight of a sum of the alcohol component and the carboxylic acid component.

From the viewpoint of a good storage property of the resultant toner, the polyester contained in the emulsified particles preferably has a softening point of 70 to 165° C. and a glass transition temperature of 50 to 85° C. The acid value of the polyester is preferably from 6 to 35 mg KOH/g, more preferably from 10 to 35 mg KOH/g and even more preferably from 15 to 35 mg KOH/g from the viewpoint of facilitated production of the emulsion. The softening point or the acid value of the polyester may be desirably adjusted by controlling the proportions of the monomer components charged, and the temperature and time used in the polycondensation reaction.

It is required that the binder resin constituting the resin particles in the emulsion has a weight-average molecular weight of 2×10⁴ to 1×10⁵. When the weight-average molecular weight of the binder resin is 2×10⁴ or more, the resulting toner can exhibit both a good low energy fusing ability and a good high-temperature anti-offset property. When the weight-average molecular weight of the binder resin is more than 1×10⁵, the resulting toner tends to be deteriorated in low energy fusing ability. From the viewpoints of a good fusing ability and a good gloss of the resulting toner, the weight-average molecular weight of the binder resin is preferably from 2×10⁴ to 9×10⁴, more preferably from 2×10⁴ to 8×10⁴, even more preferably from 2×10⁴ to 6×10⁴, and further even more preferably from 2×10⁴ to 4×10⁴. The weight-average molecular weight of the binder resin may be measured by gel permeation chromatography, more specifically, by the below-mentioned method.

The binder resin particles contain a component having a molecular weight of not less than 1×10⁵ and not more than 1×10⁶ in an amount of 2 to 15%. From the viewpoints of a good fusing ability and a good gloss of the resulting toner, the content of the above component in the binder resin particles is preferably from 2 to 13%, more preferably from 2 to 10%, even more preferably from 3 to 10% and further even more preferably from 3 to 8%. When the content of the component having a molecular weight of not less than 1×10⁵ and not more than 1×10⁶ in the binder resin particles is less than 2%, the effect of improving the fusing ability can not be exhibited. On the other hand, when the content of the above component having a molecular weight of not less than 1×10⁵ and not more than 1×10⁶ in the binder resin particles is more than 15%, the resulting toner tends to be deteriorated in low energy fusing ability. Meanwhile, in the present invention, the content of the component having a molecular weight of not less than 1×10⁵ and not more than 1×10⁶ in the binder resin particles is expressed by an area ratio (%) of the component having a molecular weight of not less than 1×10⁵ and not more than 1×10⁶ on the basis of that of whole components as measured from a molecular weight distribution obtained by the below-mentioned gel permeation chromatography (GPC).

In the present invention, the component having a molecular weight of not less than 1×10⁵ and not more than 1×10⁶ may include, for example, a crosslinked resin moiety derived from the trivalent or higher-valent alcohol component and/or the trivalent or higher-valent carboxylic acid component. The above-specified content of the above component in the emulsified resin particles can be achieved, for example, by a process for production of the emulsion including a neutralizing step conducted in an aqueous medium.

Meanwhile, when the binder resin is in the form of a mixture of a plurality of resins, the softening point, glass transition point, acid value, number-average molecular weight and melt viscosity of the binder resin mean those values of the mixture.

### Nonionic Surfactant

The resin emulsion of the present invention contains a nonionic surfactant in an amount of more than 1.0 part by weight and less than 5 parts by weight on the basis of 100 parts by weight of the binder resin. Upon production of the resin emulsion, the nonionic surfactant is used in the above-specified amount. When incorporating the above-specified amount of the nonionic surfactant, the resin emulsion can exhibit a good emulsification stability, and the resulting toner can be improved in fusing ability and heat-resistant storage property. From the same viewpoints as described above, the content of the nonionic surfactant in the resin emulsion is preferably not less than 1.5 parts by weight and less than 5 parts by weight, and more preferably not less than 2 parts by weight and less than 5 parts by weight.

In the present invention, the cloud point of the nonionic surfactant is preferably 70° C. or higher and more preferably 80° C. or higher from the viewpoint of a good emulsification thereof. Meanwhile, the cloud point of the nonionic surfactant as used herein means a temperature at which an aqueous solution of the nonionic surfactant starts to cause turbidity when the temperature of the aqueous solution is raised, and may be measured by any suitable methods conventionally known to the person skilled in the art. For example, the cloud point of the nonionic surfactant may be determined by observing, by naked eyes, a temperature at which an aqueous solution containing the nonionic surfactant undergoes solid-liquid separation when gradually raising the temperature of the aqueous solution. Alternatively, the could point of the nonionic surfactant may be determined from change in light transmittance of the aqueous solution using a spectroscope. If it is required to measure the cloud point more precisely, conventionally known optical methods for measuring a cloud point of surfactants may be directly applied to measurement of the cloud point of the nonionic surfactant.

The nonionic surfactant is not particularly limited. Examples of the nonionic surfactant include polyoxyethylene alkyl ethers, polyoxyethylene alkyl phenyl ethers, sorbitan monostearate and polyoxyethylene alkyl amines. In the present invention, among these nonionic surfactants, from the viewpoints of a good fusing ability and a good image characteristic of the resulting toner, preferred are polyoxyethylene (average molar number of addition: 10 to 60 mol) alkyl (C₈ to C₁₈) ethers, and more preferred are those polyoxyethylene alkyl ethers in which the alkyl group has 12 to 18 carbon atoms and/or the average molar number of addition of EO is from 12 to 18. Specific examples of the preferred nonionic surfactants include polyoxyethylene oleyl ether, polyoxyethylene stearyl ether and polyoxyethylene lauryl ether.

In the present invention, these nonionic surfactants may be used alone or in combination of any two or more thereof.

### Anionic Surfactant

The resin emulsion of the present invention contains an anionic surfactant in addition to the above nonionic surfactant. The resin emulsion of the present invention contains the anionic surfactant in an amount of not less than 0.1 part by weight and less than 5 parts by weight on the basis of 100 parts by weight of the binder resin. The anionic surfactant is preferably used in such a specific amount upon production of the resin emulsion. When incorporating the anionic surfactant in the above-specified amount, the resulting resin emulsion can exhibit a good emulsification stability, thereby enabling production of finer emulsified particles. From this viewpoint, the content of the anionic surfactant in the resin emulsion is more preferably from 0.3 to 4.5 parts by weight, even more preferably from 0.5 to 4 parts by weight and further even more preferably from 0.7 to 4 parts by weight on the basis of 100 parts by weight of the binder resin.

The anionic surfactant is not particularly limited. Examples of the anionic surfactant include sulfate-based surfactants, sulfonate-based surfactants, phosphate-based surfactants and soap-based surfactants. Specific examples of the anionic surfactant include sodium dodecylbenzenesulfonate, sodium dodecylsulfate, sodium alkylethersulfates, sodium alkylnaphthalenesulfonates and sodium dialkylsulfosuccinates. Among these anionic surfactants, preferred is sodium dodecylbenzenesulfonate.

In the present invention, these anionic surfactants may be used alone or in combination of any two or more thereof.

The resin particles dispersed in the resin emulsion of the present invention preferably contain the above nonionic surfactant and the above anionic surfactant in such an amount that a weight ratio of the anionic surfactant to the nonionic surfactant (anionic surfactant/nonionic surfactant) is from 0.2 to 0.9 from the viewpoint of achieving both a good emulsification of the resin and a good heat-resistant storage property of the resulting toner. The weight ratio of the anionic surfactant to the nonionic surfactant (anionic surfactant/nonionic surfactant) in the resin emulsion is more preferably from 0.2 to 0.85 and even more preferably from 0.2 to 0.8.

In the present invention, the contents of the nonionic surfactant and the anionic surfactant in the resin emulsion are substantially the same as the amounts of the nonionic surfactant and the anionic surfactant used when emulsifying the resin. The content of the resin in the resin emulsion may be measured by the below-mentioned method.

### Other Components

Further, the resin emulsion of the present invention may also contain a colorant, a charge controlling agent, a releasing agent, the other surfactants, a fixing improver, etc.

The colorant used in the present invention is not particularly limited, and may be appropriately selected from known black, yellow, magenta and cyan colorants, etc. Specific examples of the colorant include various pigments such as carbon blacks, inorganic composite oxides, Chrome Yellow, Hansa Yellow, Benzidine Yellow, Threne Yellow, Quinoline Yellow, Permanent Orange GTR, Pyrazolone Orange, Vulcan Orange, Watchung Red, Permanent Red, Brilliant Carmine 3B, Brilliant Carmine 6B, quinacridones, DuPont Oil Red, Pyrazolone Red, Lithol Red, Rhodamine B Lake, Lake Red C, red iron oxide, Methylene Blue Chloride, Phthalocyanine Blue, Phthalocyanine Green and Malachite Green Oxalate; and various dyes such as acridine dyes, xanthene dyes, azo dyes, benzoquinone dyes, azine dyes, anthraquinone dyes, indigo dyes, thioindigo dyes, phthalocyanine dyes, Aniline Black dyes and thiazole dyes. These colorants may be used alone or in combination of any two or more thereof.

The content of the colorant in the resin emulsion is preferably 25 parts by weight or less, more preferably from 0.01 to 10 parts by weight and even more preferably from 3 to 10 parts by weight on the basis of 100 parts by weight of the binder resin from the viewpoints of a good tinting power and a good transparency of the obtained images. The colorant may be added in the above-specified amount to the resin emulsion upon production of the resin emulsion and/or upon production of the toner.

The colorant may be used in the form of any of a dried powder, a master batch prepared by previously dispersing the colorant in the resin, and a colorant-containing aqueous material such as a wet cake and a water dispersion.

Examples of the releasing agent include low-molecular weight polyolefins such as polyethylene, polypropylene and polybutene; silicones exhibiting a softening point upon heating; fatty acid amides such as oleamide, erucamide, ricinolamide and stearamide; vegetable waxes such as carnauba wax, rice wax, candelilla wax, haze wax and jojoba oil; animal waxes such as beeswax; mineral and petroleum waxes such as montan wax, ozokerite, ceresin, paraffin wax, microcrystalline wax and Fischer-Tropsch wax; and the like. These releasing agents are preferably used as such or in the form of a dispersion in an aqueous medium, and may be used alone or in combination of any two or more thereof.

The content of the releasing agent in the resin emulsion is usually from about 1 to 20 parts by weight and preferably from 2 to 15 parts by weight on the basis of 100 parts by weight of the binder resin in view of attaining good effects due to addition thereof and preventing occurrence of adverse influence thereof on chargeability. The releasing agent may be added in the above-specified amount to the resin emulsion upon production of the resin emulsion and/or upon production of the toner.

Examples of the charge controlling agent include metal salts of benzoic acid, metal salts of salicylic acid, metal salts of alkylsalicylic acids, metal salts of catechol, metal-containing bisazo dyes, tetraphenyl borate derivatives, quaternary ammonium salts and alkyl pyridinium salts.

The content of the charge controlling agent in the resin emulsion is preferably 10 parts by weight or less and more preferably from 0.01 to 5 parts by weight on the basis of 100 parts by weight of the binder resin. The charge controlling agent may be added in the above-specified amount to the resin emulsion upon production of the resin emulsion and/or upon production of the toner.

Examples of the surfactants other than the above nonionic surfactant and anionic surfactant include cationic surfactants such as amine salt-type surfactants and quaternary ammonium salt-type surfactants. Specific examples of the cationic surfactants include alkylbenzenedimethyl ammonium chlorides, alkyltrimethyl ammonium chlorides and distearyl ammonium chlorides.

### Resin Emulsion

The resin emulsion of the present invention contains the binder resin containing the polyester having a constitutional unit derived from at least one component selected from the group consisting of a trivalent or higher-valent alcohol component and a trivalent or higher-valent carboxylic acid component, the nonionic surfactant, and the anionic surfactant. The resin emulsion preferably contains the binder resin particles which have a weight-average molecular weight of from 2×10⁴ to 1×10⁵, and contain a component having a molecular weight of not less than 1×10⁵ and not more than 1×10⁶ in an amount of 2 to 15%, and the nonionic surfactant is preferably contained in the resin emulsion in an amount of more than 1.0 part by weight and less than 5 parts by weight on the basis of 100 parts by weight of the binder resin.

That is, one feature of the resin emulsion of the present invention resides in that the resin emulsion is produced by emulsifying the resin in the presence of specific amounts of the nonionic surfactant and the anionic surfactant. In the resin emulsion, since the anionic surfactant is efficiently dispersed in the resin softened by action of the nonionic surfactant, it is considered that the resin can be emulsified even when the surfactants are used in a smaller amount than conventionally. As a result, the effect of reducing the amount of the surfactants remaining in the resin emulsion, in particular, in the toner can be attained as described previously. Therefore, from the above viewpoints, in the present invention, the anionic surfactant is preferably added upon production of the resin emulsion.

The volume-median particle size (D₅₀) of the resin particles contained in the resin emulsion is preferably from 0.02 to 2 μm, more preferably from 0.05 to 1 μm and even more preferably from 0.05 to 0.6 μm for the purpose of uniform aggregation thereof in the subsequent aggregating step. As to the particle size distribution of the resin particles, from the same viewpoints as described above, the CV value (Standard Deviation of Particle Size Distribution/Volume-Median Particle Size (D₅₀)×100) is preferably 60 or less, more preferably 45 or less and even more preferably 35 or less. Meanwhile, the “volume-median particle size (D₅₀)” as used herein means a particle size at which a cumulative volume frequency calculated on the basis of a volume fraction of particles from a smaller particle size side thereof is 50%. The volume-median particle size may be measured by the below-mentioned method.

The resin emulsion of the present invention is preferably produced by the below-mentioned method. In addition, it is preferred that the resin emulsion is obtained by emulsifying the binder resin containing a polyester having a constitutional unit derived from a trivalent or higher-valent alcohol component and/or a trivalent or higher-valent carboxylic acid component in an aqueous medium in the presence of the nonionic surfactant and the anionic surfactant, and contains the binder resin particles having a weight-average molecular weight of from 2×10⁴ to 1×10⁵, and containing a component having a molecular weight of not less than 1×10⁵ and not more than 1×10⁶ in an amount of 2 to 15%, and the nonionic surfactant is contained in the resin emulsion in an amount of more than 1.0 part by weight and less than 5 parts by weight on the basis of 100 parts by weight of the binder resin.

In the method of “emulsifying the binder resin containing a polyester having a constitutional unit derived from a trivalent or higher-valent alcohol component and/or a trivalent or higher-valent carboxylic acid component in an aqueous medium in the presence of the nonionic surfactant and the anionic surfactant”, the binder resin containing the above-described polyester may be emulsified in the presence of the above-described nonionic surfactant and anionic surfactant. Meanwhile, the other features of the resin emulsion are the same as described above.

### Process for Producing Resin Emulsion

The process for producing the resin emulsion according to the present invention includes the steps of (a) mixing a resin containing a polyester having a constitutional unit derived from at least one component selected from the group consisting of a trivalent or higher-valent alcohol component and a trivalent or higher-valent carboxylic acid component, an anionic surfactant, and a nonionic surfactant in an amount of more than 1.0 part by weight and less than 5 parts by weight on the basis of 100 parts by weight of the resin, with each other at a temperature not lower than the temperature calculated from “softening point of the resin −(minus) 10° C.”; and (b) neutralizing the resulting mixture obtained in the step (a) with a basic compound in an aqueous medium at a temperature not higher than the temperature calculated from “softening point of the resin −(minus) 10° C.”.

When the resin, the nonionic surfactant and the anionic surfactant are mixed with each other at a temperature not lower than the temperature calculated from “softening point of the resin −(minus) 10° C.”, it is possible to obtain a uniform mixture of the resin and the surfactants. As a result, the substantial softening point of the resin is lowered by action of the nonionic surfactant, so that the anionic surfactant can be efficiently dispersed in the resin. These effects enable production of finer emulsified particles even when using the crosslinked polyester. In the following, the respective steps are explained.

### (Step (a))

In the step (a), the resin containing a polyester having a constitutional unit derived from at least one component selected from the group consisting of a trivalent or higher-valent alcohol component and a trivalent or higher-valent carboxylic acid component, an anionic surfactant, and a nonionic surfactant in an amount of more than 1.0 part by weight and less than 5 parts by weight on the basis of 100 parts by weight of the resin, are mixed with each other at a temperature not lower than the temperature calculated from “softening point of the resin −(minus) 10° C.”.

The resin containing a polyester having a constitutional unit derived from at least one component selected from the group consisting of a trivalent or higher-valent alcohol component and a trivalent or higher-valent carboxylic acid component, the nonionic surfactant and the anionic surfactant which are used in the step (a) are respectively the same as those described previously.

More specifically, in the step (a), for example, the binder resin, the nonionic surfactant, the anionic surfactant and, if required, various other additives such as a colorant are mixed with each other. The amounts of the nonionic surfactant and the anionic surfactant used in the step (a) are the same as the contents of these surfactants in the resin emulsion as described previously.

In the step (a), from the viewpoint of a good emulsifiability, the mixing of the respective components is carried out at a temperature not lower than the temperature calculated from “softening point of the resin −(minus) 10° C.”, preferably not lower than the temperature calculated from “softening point of the resin −(minus) 5° C.” and more preferably not lower than the softening point of the resin. The upper limit of the temperature upon the mixing is preferably 200° C. in order to present decomposition of the polyester and the surfactants. From the above viewpoints, the temperature used upon the mixing is preferably not lower than the temperature calculated from “softening point of the resin −(minus) 10° C.” and not higher than 200° C., more preferably not lower than the temperature calculated from “softening point of the resin −(minus) 5° C.” and not higher than 200° C., and even more preferably not lower than the softening point of the resin and not higher than 190° C. The resulting mixture may be in the form of not only a solid but also any of a liquid, a paste and a melt having a viscosity intermediate between those of the liquid and paste, as long as the nonionic surfactant and anionic surfactant are uniformly mixed with the resin. In the present invention, it is preferred that the nonionic surfactant act for lowering a substantial softening point of the resin, and the anionic surfactant be efficiently dispersed in the resin.

### (Step (b))

In the step (b), the mixture obtained in the step (a) is neutralized with a basic compound in an aqueous medium at a temperature not higher than the softening point of the above resin.

The aqueous medium as used herein means a water-based medium which is not composed substantially of an organic solvent solely, and the water-based medium contains water as a main component, i.e., has a water content of 50% or more. From the viewpoint of a good environmental suitability, the water content in the aqueous medium is preferably 80% by weight or more, more preferably 90% by weight or more and most preferably 100% by weight.

Examples of components other than water which may be contained in the aqueous medium include water-soluble organic solvents such as methanol, ethanol, isopropanol, butanol, acetone, methyl ethyl ketone and tetrahydrofuran. Among these organic solvents, from the viewpoint of less inclusion into the toner, preferred are alcohol-based organic solvents incapable of dissolving resins therein such as methanol, ethanol, isopropanol and butanol. In the present invention, the binder resin is preferably dispersed in the form of fine particles in water solely substantially without using any organic solvent.

As the basic compound, there are preferably used alkalis capable of enhancing a surface active performance of the polyester when the polyester forms a salt with these alkalis. Specific examples of the basic compound include inorganic basic compounds, e.g., alkali metal hydroxides such as sodium hydroxide, potassium hydroxide and lithium hydroxide, weak acid salts of these alkali metal hydroxides such as carbonates and acetates or partially neutralized salts thereof, and ammonia; and organic basic compounds, e.g., alkyl amines such as methylamine, dimethylamine, trimethylamine, ethylamine, diethylamine and triethylamine, alkanol amines such as diethanol amine, and fatty acid salts such as sodium succinate and sodium stearate. Among these basic compounds, from the viewpoint of efficiently conducting the neutralization, preferred is potassium hydroxide. These basic compounds may be used alone or in combination of any two or more thereof.

The basic compound may be used in the form of a basic aqueous medium prepared by adding the basic compound to the above aqueous medium. The concentration of the basic compound in the basic aqueous medium is preferably from 1 to 20% by weight, preferably from 1 to 10% by weight and more preferably from 1.5 to 7.5% by weight.

The basic compound may be used for the purpose of neutralizing the mixture obtained in the step (a). From the viewpoint of effectively carrying out the neutralization, the basic compound is preferably added in the step (b), and more preferably added in the step (b) without addition thereof in the step (a). More specifically, after the respective surfactants are dispersed in the resin in the step (a), the basic compound is added in the step (b), so that the neutralization can be carried out in an effective and uniform manner.

From the viewpoint of uniformly neutralizing the resin in the step (b), the neutralization is preferably conducted while stirring for a predetermined period of time. The stirring time is preferably 30 min or longer and more preferably 1 h or longer.

From the viewpoints of fully conducting the neutralization, inhibiting formation of excessively large emulsified particles in the emulsifying treatment in the subsequent step, and requiring no special apparatus for heating treatment for the neutralization, the neutralization temperature is a temperature not higher than the softening point of the above resin, preferably a temperature not higher than the temperature calculated from “softening point of the resin −(minus) 5° C.”, and more preferably a temperature not higher than the temperature calculated from “softening point of the resin −(minus) 10° C.”. The lower limit temperature for the neutralization treatment is a softening initiation temperature of the above resin from the viewpoint of attaining a good emulsification property and fully conducting the neutralization. From the above viewpoints, the temperature used upon the neutralization is preferably not lower than the softening initiation temperature of the resin and not higher than the temperature calculated from “softening point of the resin −(minus) 5° C.”, and more preferably not lower than the softening initiation temperature of the resin and not higher than the temperature calculated from “softening point of the resin −(minus) 10° C.”. Meanwhile, the “softening initiation temperature” as used herein means a temperature at which softening of the resin is started, more specifically the temperature as measured by the below-mentioned method.

In the neutralizing step, the resin is not necessarily neutralized entirely (100%) and may be neutralized to such an extent as to impart thereto a hydrophilicity required for producing the emulsified particles in the next step. For example, when using a high-hydrophilic resin containing a large number of polar groups, the degree of neutralization of such a resin may be low, whereas when using a low-hydrophilic resin, the degree of neutralization of the resin is preferably high. In the present invention, the degree of neutralization of the resin is preferably 50% or higher, more preferably from 60 to 100% and even more preferably from 70 to 100%. The degree of neutralization is generally expressed by a ratio between numbers of moles of the acid group before and after the neutralization (number of moles of acid group after neutralization/number of moles of acid group before neutralization). More specifically, for example in the case where the polyester is a resin to be neutralized, the degree of neutralization thereof may be determined by measuring an acid value thereof before and after the neutralization.

In the process of the present invention, it is preferred that an aqueous medium be added to the mixture neutralized in the step (b) to subject the binder resin to phase reversal and emulsification therein. More specifically, after neutralizing the mixture in the step (b), while stirring the mixture, the aqueous liquid is added thereto at the same temperature as that of the neutralizing step, preferably at a temperature not higher than the temperature calculated from “softening point of the resin −(minus) 10° C.” to subject the binder resin to phase reversal and emulsification, thereby enabling production of a resin emulsion containing finer resin particles.

The aqueous medium to be added to the mixture may be the same water-based medium as used in the step (b). The rate of addition of the aqueous medium is preferably from 0.5 to 50 g/min, more preferably from 0.5 to 30 g/min and even more preferably from 1 to 20 g/min per 100 g of the resin from the viewpoint of effectively conducting the emulsification. The rate of addition of the aqueous medium may be usually maintained until an 0/W type emulsion is substantially formed. Therefore, the rate of addition of the aqueous medium after forming the 0/W type emulsion is not particularly limited. The amount of the aqueous medium added to the mixture is preferably from 100 to 2,000 parts by weight and more preferably from 150 to 1,500 parts by weight on the basis of 100 parts by weight of the resin forming the resin particles from the viewpoint of obtaining uniform aggregated particles in the subsequent aggregating treatment.

The solid concentration of the thus obtained resin emulsion is preferably from 5 to 50% by weight, more preferably from 5 to 45% by weight and even more preferably from 10 to 40% by weight from the viewpoints of a good stability of the resulting emulsion and a good handling property of the resin emulsion and occurrence of uniform aggregation in the subsequent aggregating step.

The resin emulsion of the present invention may also be produced by alternative methods. For example, there may be mentioned such a method in which a polycondensable monomer as a raw material of the aimed resin particles is emulsified and dispersed in an aqueous medium in the presence of the above nonionic surfactant and anionic surfactant by mechanical shearing or application of ultrasonic wave. In this case, if required, a polycondensation catalyst and various additives such as surfactants may be added to the water-soluble medium. In addition, the resulting solution may be subjected, for example, to heat treatment, thereby allowing the polycondensation to proceed. For example, in the case where the polyester is used as the resin, the polycondensable monomer of the polyester and a polycondensation catalyst therefor may be used.

### [Toner for Electrophotography and Process for Producing the Toner]

The toner for electrophotography according to the present invention is produced from the above resin emulsion. More specifically, the toner for electrophotography according to the present invention is produced by the process including the steps of (1) obtaining the resin emulsion by the method including the above steps (a) and (b); and (2) aggregating and coalescing the emulsified resin particles contained in the resin emulsion obtained in the step (1). The above step (1) is as described previously. In the following, the step (2) is explained.

### (Step (2))

The step (2) includes a step for aggregating the emulsified resin particles contained in the resin emulsion obtained in the step (1) (aggregating step) and a step for coalescing the resin particles (coalescing step).

In the aggregating step, the solid concentration of the resin emulsion used therein is preferably controlled to the above-specified value in order to cause uniform aggregation of the resin particles. From the viewpoint of achieving both a good dispersion stability of the mixed liquid and a good aggregating property of fine particles of the binder resin, etc., the pH value of the system is preferably controlled to the range of from 2 to 10, more preferably from 2 to 9 and even more preferably from 3 to 8.

From the same viewpoints as described above, the temperature of the system in the aggregating step is preferably not higher than a glass transition point of the binder resin and more preferably a temperature not higher than the temperature calculated from “glass transition point of the resin −(minus) 10° C.”.

In the aggregating step, in order to effectively carry out the aggregation, an aggregating agent is preferably added.

Examples of the aggregating agent include a cationic surfactant in the form of a quaternary salt, an organic aggregating agent such as polyethyleneimine, and an inorganic aggregating agent such as an inorganic metal salt, an ammonium salt and a divalent or higher-valent metal complex. The inorganic metal salt includes, for example, metal salts such as sodium sulfate, sodium chloride, calcium chloride, calcium nitrate, barium chloride, magnesium chloride, zinc chloride, aluminum chloride and aluminum sulfate; and inorganic metal salt polymers such as poly(aluminum chloride), poly(aluminum hydroxide) and poly(calcium sulfide). In the present invention, from the viewpoints of controlling a particle size of the toner with a high accuracy and achieving a sharp particle size distribution thereof, a monovalent salt is preferably used as the aggregating agent. The “monovalent salt” as used herein means that a valence of a metal ion or an anion constituting the salt is 1. Examples of the monovalent salt as the aggregating agent include organic aggregating agents such as cationic surfactants in the form of a quaternary salt, and inorganic aggregating agents such as inorganic metal salts and ammonium salts. In the present invention, among these aggregating agents, from the viewpoints of controlling a particle size of the toner with a high accuracy and achieving a sharp particle size distribution thereof, preferred are water-soluble nitrogen-containing compounds having a molecular weight of 350 or less.

The water-soluble nitrogen-containing compounds having a molecular weight of 350 or less are preferably acidic compounds in order to rapidly aggregate the resin particles. The pH value of an aqueous solution containing 10% by weight of the water-soluble nitrogen-containing compound is preferably from 4 to 6 and more preferably from 4.2 to 6 as measured at 25° C. Also, from the viewpoints of a good charging property under high-temperature and high-humidity conditions, etc., the water-soluble nitrogen-containing compounds preferably have a molecular weight of 350 or less and more preferably 300 or less. Examples of the water-soluble nitrogen-containing compounds include ammonium salts such as ammonium halides, ammonium sulfate, ammonium acetate, ammonium benzoate and ammonium salicylate; and quaternary ammonium salts such as tetraalkyl ammonium halides. From the viewpoint of a good productivity, among these compounds, preferred are ammonium sulfate (pH value of 10 wt % aqueous solution thereof as measured at 25° C. (hereinafter referred to merely as a “pH value”): 5.4), ammonium chloride (pH value: 4.6), tetraethyl ammonium bromide (pH value: 5.6) and tetrabutyl ammonium bromide (pH value: 5.8).

The amount of the aggregating agent used varies depending upon the valence of electric charge of the aggregating agent used. When using a monovalent aggregating agent, the amount of the aggregating agent used is preferably from 2 to 50 parts by weight, more preferably from 3.5 to 40 parts by weight and even more preferably from 3.5 to 30 parts by weight on the basis of 100 parts by weight of the binder resin from the viewpoint of a good aggregating property.

The aggregating agent to be added is preferably used in the form of a solution in an aqueous medium. Upon adding the aggregating agent to the resin emulsion and after completion of the addition, it is preferred that the obtained resin emulsion be fully stirred.

In order to uniformly aggregate the resin emulsion, it is preferred that the aggregating agent be added thereto after suitably controlling the pH value of the system and at a temperature not higher than a glass transition point of the resin forming the resin particles and preferably not higher than the temperature calculated from the “glass transition point of the resin −(minus) 10° C.”. The aggregating agent may be added either at one time, intermittently or continuously. In addition, upon adding the aggregating agent and after completion of the addition, the obtained resin emulsion is preferably fully stirred.

In the present invention, after aggregating the emulsified resin particles, a surfactant is preferably added to the resulting emulsion, and more preferably at least one salt selected from the group consisting of alkylethersulfuric acid salts, alkylsulfuric acid salts and linear alkylbenzenesulfonic acid salts is added thereto.

The alkylethersulfuric acid salts are preferably represented by the following formula (1):

R¹—O—(CH₂CH₂O)ₚSO₃M¹ (1).

In the formula (1), R¹ represents an alkyl group. From the viewpoints of a good adsorption to the aggregated particles and a good residual property in the toner, the alkyl group as R¹ preferably has 6 to 20 carbon atoms and more preferably 8 to 15 carbon atoms. The suffix p represents an average molar number of addition ranging from 0 to 15, and is preferably from 1 to 10 and more preferably from 1 to 5 from the viewpoint of well controlling a particle size of the aggregated particles. M¹ represents a monovalent cation, and is preferably sodium, potassium or ammonium and more preferably sodium or ammonium from the viewpoint of well controlling a particle size of the aggregated particles.

Also, the linear alkylbenzenesulfonic acid salts are not particularly limited. From the viewpoints of a good adsorption into the aggregated particles and a good residual property in the toner, the linear alkylbenzenesulfonic acid salts are preferably those salts represented by the following formula (2):

R²-Ph-SO₃M² (2).

In the formula (2), R² represents a linear alkyl group. Examples of R² include the same linear alkyl groups among those alkyl groups exemplified as R¹ above. Ph represents a phenyl group, and M² represents a monovalent cation. As the suitable linear alkylbenzenesulfonic acid salts, there are preferably used sodium sulfate salts thereof.

The above surfactant is added in an amount of preferably from 0.1 to 15 parts by weight, more preferably from 0.1 to 10 parts by weight and even more preferably from 0.1 to 8 parts by weight on the basis of 100 parts by weight of the resin forming the aggregated particles from the viewpoints of a good aggregation stopping property and a good residual property in the resultant toner.

In the present invention, the volume-median particle size (D₅₀) of the aggregated particles is preferably from 1 to 10 μm, more preferably from 2 to 10 μm and even more preferably from 2 to 9 μm from the viewpoints of a high image quality.

In the present invention, from the viewpoints of preventing occurrence of run-off of the releasing agent such as waxes, etc., or maintaining electric charge amounts between respective colors in a color toner at the same level, additional finer emulsified resin particles may be added to the emulsified resin particles contained in the resin emulsion obtained in the step (1) at one time or may be intermittently added thereto in plural divided parts.

The finer emulsified resin particles to be added to the emulsified resin particles of the present invention are not particularly limited. For example, the finer emulsified resin particles may be produced by the same method as used for production of the emulsified resin particles of the present invention.

In the present invention, the finer emulsified resin particles may be the same as or different from the emulsified resin particles of the present invention. From the viewpoint of achieving both a good low energy fusing ability and a good storage stability of the resulting toner, it is preferred that the finer emulsified resin particles which are different in kind from the emulsified resin particles of the present invention be subsequently added either at one time or intermittently in plural divided parts.

In this step, the finer emulsified resin particles may be mixed with the aggregated particles obtained by adding the aggregating agent to the resin emulsion of the present invention.

In the present invention, the time of addition of the finer emulsified resin particles is not particularly limited. However, from the viewpoint of a good productivity, the finer emulsified resin particles are preferably added for a period of from completion of addition of the aggregating agent to the subsequent coalescing step.

In this step, the resin emulsion of the present invention may be mixed with the aggregated particles obtained by adding the aggregating agent to the finer emulsified resin particles.

The blending ratio of the emulsified resin particles of the present invention to the finer emulsified resin particles (emulsified resin particles of the present invention/finer emulsified resin particles) is preferably from 0.1 to 2.0, more preferably from 0.2 to 1.5 and even more preferably from 0.3 to 1.0 in terms of a weight ratio therebetween from the viewpoint of achieving both a good low energy fusing ability and a good heat-resistant storage property of the resulting toner.

The thus obtained aggregated particles are then subjected to the step for coalescing the aggregated particles (coalescing step).

In the coalescing step, the aggregated particles obtained in the above aggregating step are coalesced.

In the present invention, the aggregated particles obtained in the aggregating step are heated to obtain coalesced particles. In the coalescing step, the temperature of the system is preferably controlled to the same temperature as used in the system of the aggregating step or higher. The temperature of the system used in the coalescing step is more preferably not lower than the glass transition point of the binder resin, more preferably not higher than the temperature calculated from the “softening point of the resin +(plus) 20° C.”; more preferably not lower than the temperature calculated from the “grass transition point of the resin +(plus) 5° C.” and not higher than the temperature calculated from the “softening point of the resin +(plus) 15° C.”; and even more preferably not lower than the temperature calculated from the “grass transition point of the resin +(plus) 10° C.” and not higher than the temperature calculated from the “softening point of the resin +(plus) 10° C.” from the viewpoints of well controlling a particle size, a particle size distribution and a shape of the toner as desired, and attaining a good fusibility of the aggregated particles. In addition, the stirring rate used in the coalescing step is preferably a rate at which the aggregated particles are not precipitated.

The coalescing step may be carried out simultaneously with the aggregating step, for example, by continuously raising the temperature of the system while stirring, or by raising the temperature of the system to the temperature at which both the aggregation step and the coalescing step can be performed and then continuously stirring the system at that temperature.

The volume median particle size (D₅₀) of the coalesced particles is preferably from 1 to 10 μm, more preferably from 2 to 10 μm and even more preferably from 3 to 9 μm from the viewpoint of a high image quality.

The thus obtained coalesced particles may be appropriately subjected to a liquid-solid separation step such as filtration, a washing step, a drying step, etc., if required, thereby obtaining toner mother particles.

In the washing step, the coalesced particles are preferably washed with an acid to remove metal ions from the surface of the respective toner mother particles for the purpose of ensuring sufficient charging characteristics and a good reliability of the resultant toner. The washing procedure is preferably carried out plural times.

In addition, in the drying step, any optional methods such as vibration-type fluidization drying method, spray-drying method, freeze-drying method and flash jet method may be employed. The water content in the toner mother particles obtained after drying is preferably adjusted to 1.5% by weight or less and more preferably 1.0% by weight or less from the viewpoint of good charging characteristics of the resulting toner.

In addition, in the drying step, any optional methods such as vibration-type fluidization drying method, spray-drying method, freeze-drying method and flash jet method may be employed. The water content in the toner particles obtained after drying is preferably adjusted to 1.5% by weight or less, more preferably 1.0% by weight or less and still more preferably 0.5% by weight or less from the viewpoint of good charging characteristics of the resulting toner.

The toner of the present invention may be obtained by adding an auxiliary agent such as a fluidizing agent as an external additive to treat the surface of the coalesced particles therewith. As the external additive, there may be used known fine particles. Examples of the fine particles include inorganic fine particles such as fine silica particles whose surface is subjected to a hydrophobic treatment, fine titanium oxide particles, fine alumina particles, fine cerium oxide particles and carbon blacks; and fine polymer particles such as fine particles made of polycarbonates, polymethyl methacrylate, silicone resins, etc.

The amount of the external additive blended in the toner is preferably from 1 to 5 parts by weight and more preferably from 1.5 to 3.5 parts by weight on the basis of 100 parts by weight of the toner mother particles before being treated with the external additive. Here, when a hydrophobic silica is used as the external additive, the hydrophobic silica is preferably added in an amount of from 1 to 3 parts by weight on the basis of 100 parts by weight of the toner mother particles before being treated with the external additive.

The toner for electrophotography obtained according to the present invention may be used in the form of a one-component system developer or a tow-component system developer formed by mixing the toner with a carrier.

### EXAMPLES

The present invention is described in more detail by referring to the following examples, etc. However, it should be noted that these examples, etc., are only illustrative and not intended to limit the invention thereto. In the following examples, etc, various properties were measured and evaluated by the following methods.

### [Acid Value of Resins]

Determined according to JIS K0070. However, with respect to the solvent used upon the measurement, the mixed solvent of ethanol and ether was replaced with a mixed solvent containing acetone and toluene at a volume ratio of 1:1.

### [Softening Point, Softening Initiation Temperature and Glass Transition Point of Resins]

### (1) Softening Point

Using a flow tester “CFT-500D” available from Shimadzu Corporation, 1 g of a sample was extruded through a nozzle having a die pore diameter of 1 mm and a length of 1 mm while heating the sample at a temperature rise rate of 6° C./min and applying a load of 1.96 MPa thereto by a plunger. The softening point was determined as the temperature at which a half of the amount of the sample was flowed out when plotting a downward movement of the plunger of the flow tester relative to the temperature.

### (2) Softening Initiation Temperature

The temperature at which the plunger started the downward movement in the above measurement of the softening point was determined as a softening initiation temperature of the resins.

### (3) Glass Transition Point

Using a differential scanning calorimeter (“DSC 210” commercially available from Seiko Instruments & Electronic, Ltd.), a sample was heated to 200° C. and then cooled from 200° C. to 0° C. at a temperature drop rate of 10° C./min, and thereafter heated again at temperature rise rate of 10° C./min to measure a glass transition point thereof. When a peak was observed at a temperature lower by 20° C. or more than the softening point, the peak temperature was read as the glass transition point. Whereas, when a shift of the characteristic curve was observed without any peaks at the temperature lower by 20° C. or more than the softening point, the temperature at which a tangential line having a maximum inclination of the curve in the portion of the curve shift was intersected with an extension of the baseline on the high-temperature side of the curve shift was read as the glass transition point. Meanwhile, the glass transition point is a property inherent to an amorphous portion of the resin, which may be generally observed in an amorphous polyester, or may also be observed in an amorphous portion of a crystalline polyester in some cases.

### [Weight-Average Molecular Weight of Resins]

The weight-average molecular weight was calculated from the molecular weight distribution measured by gel permeation chromatography according to the following method.

### (1) Preparation of Sample Solution

The resin was dissolved in chloroform to prepare a solution having a concentration of 0.5 g/100 mL. The resultant solution was then filtered through a fluororesin filter (“FP-200” commercially available from Sumitomo Electric Industries, Ltd.) having a pore size of 2 μm to remove insoluble components therefrom, thereby obtaining a sample solution.

### (2) Determination of Molecular Weight Distribution

Using the below-mentioned analyzer, chloroform was allowed to flow therethrough at a rate of 1 mL/min, and the column was stabilized in a thermostat at 40° C. One hundred microliters of the sample solution was injected to the column to determine a molecular weight distribution of the sample. The molecular weight of the sample was calculated on the basis of a calibration curve previously prepared. The calibration curve of the molecular weight was prepared by using several kinds of monodisperse polystyrenes (those polystyrenes having molecular weights of 2.63×10³, 2.06×10⁴ and 1.02×10⁵ available from Toso Company Ltd.; and those polystyrenes having molecular weights of 2.10×10³, 7.00×10³ and 5.04×10⁴ available from GL Science Inc.) as standard samples.

Analyzer: CO-8010 (commercially available from Toso Company Ltd.)

Column: GMHLX+G3000HXL (commercially available from Toso Company Ltd.)

Meanwhile, when measuring the softening point, glass transition point and weight-average molecular weight of the emulsified resin particles contained in the resin emulsion, the resin emulsion was freeze-dried to remove the solvent therefrom, and then the thus obtained solid was subjected to the measurement.

[Content of Component Having Molecular Weight of not Less than 10⁵ and not More than 10⁶ in Resins Contained in Emulsified Particles]

The content of the above component was calculated as an area percent (%) of the corresponding region in a chart of molecular weight distribution obtained in the above measurement for molecular weight of the resins.

### [Particle Size of Emulsified Resin Particles]

Using a laser diffraction particle size analyzer “LA-920” commercially available from Horiba Ltd., a cell for the measurement was filled with distilled water, and a volume-average particle size (D₄) of the particles was measured at a concentration at which an absorbance thereof fell within an adequate range. The particle size distribution was expressed by the CV value calculated according to the following formula:

CV Value=(Standard Deviation of Particle Size Distribution/Volume-Average Particle Size (D₄)×100).

### [Solid Concentration of Emulsion]

Using an infrared moisture meter “FD-230” available from Kett Electronic Laboratory, 5 g of the emulsion was dried at 150° C. to measure a water content (%) thereof on a wet base in a measuring mode 96 (monitoring time: 2.5 min/variation range: 0.05%). The solid concentration of the emulsion was calculated according to the following formula:

Solid concentration (%)=100−M

wherein M is a water content (%) on a wet base which is represented by the formula: [(W−W₀)/W]×100 wherein W is a weight of the sample before measurement (initial weight of the sample); and W₀ is a weight of the sample after measurement (absolute dry weight).

### [Particle Sizes of Aggregated Particles, Coalesced Particles and Toner]

Measuring Apparatus: Coulter Multisizer II (commercially available from Beckman Coulter Inc.)

Aperture Diameter: 50 μm

Analyzing Software: Coulter Multisizer AccuComp Ver. 1.19 (commercially available from Beckman Coulter Inc.)

Electrolyte Solution: “Isotone II” (commercially available from Beckman Coulter Inc.)

Dispersing Solution: The dispersing solution was prepared by dissolving “EMULGEN 109P” (commercially available from Kao Corporation; polyoxyethylene lauryl ether; HLB: 13.6) in the above electrolyte solution such that the concentration of “EMULGEN 109P” in the obtained solution was 5% by weight.

Dispersing Conditions: Ten milligrams of a sample to be measured was added to 5 mL of the dispersing solution, and dispersed using an ultrasonic disperser for 1 min. Thereafter, 25 mL of the electrolyte solution was added to the dispersion, and the obtained mixture was further dispersed using the ultrasonic disperser for 1 min to prepare a sample dispersion.

Measuring Conditions: The thus prepared sample dispersion was added to 100 mL of the electrolyte solution, and after controlling a concentration of the resultant dispersion such that the determination for particle sizes of 30000 particles was completed within 20 s, the particle sizes of 30000 particles were measured under such a concentration condition, and a volume-median particle size (D₅₀) thereof was determined from the thus measured particle size distribution.

### [Content of Surfactants in Resin Emulsion]

The content of surfactants in the resin emulsion was quantitatively determined by the following ¹H-NMR method. That is, 0.3 g of the solid obtained by freeze-drying the resin emulsion to remove the solvent therefrom was dissolved in 5 mL of chloroform, and then 5 mL of heavy water was added to the resulting solution to extract the surfactants into a water phase. Then, TSP was added as an internal standard to the water phase, and the resulting mixture was subjected to measurement of ¹H-NMR to determine contents of the surfactants therein. The NMR measurement was carried out using “FT-NMR MERCURY 400” available from Varian Inc.

### [Heat-Resistant Storage Property]

Ten grams of a toner was charged into a 20-mL polymer bottle, and allowed to stand under environmental conditions of a temperature of 50° C. and a relative humidity of 40% RH for 48 h with the bottle being kept opened. Thereafter, the toner was measured for its aggregating degree using a powder tester available from Hosokawa Micron Corporation, to evaluate an anti-blocking property thereof according to the following ratings. The results are shown in Table 3. Meanwhile, the measurement of the aggregating degree using the powder tester was specifically conducted as follows.

On a vibrating table of the powder tester, three sieves having different mesh sizes of 250 μm, 149 μm and 74 μm were respectively set to an upper stage, an intermediate stage and a lower stage of the tester in this order, and 2 g of the toner were placed on the upper stage sieve and vibrated to measure a weight of the toner as a reside on the respective sieves.

The aggregating degree (%) of the toner was determined from the thus measured weights of the toner according to the following formula:

Aggregating Degree (%)=a+b+c

wherein a=[(weight of residual toner on the upper stage sieve)/2 (g)]×100; b=[(weight of residual toner on the intermediate stage sieve)/2 (g)]×100×(⅗); and c=[(weight of residual toner on the lower stage sieve)/2 (g)]×100×(⅕).

### Evaluation Criteria

A: Aggregating degree was less than 10, and storage stability was very good;

B: Aggregating degree was not less than 10 but less than 20, and storage stability was good; and

C: Aggregating degree was not less than 20, and storage stability was poor.

### Production Example 1

### Production of Polyester A

A four-necked flask equipped with a nitrogen inlet tube, a dehydration tube, a stirrer and a thermocouple was charged with 1750 g of polyoxypropylene (2.2)-2,2-bis(4-hydroxyphenyl)propane, 1625 g of polyoxyethylene (2.0)-2,2-bis(4-hydroxyphenyl)propane, 945 g of terephthalic acid, 134 g of dodecenylsuccinic anhydride, 396 g of trimellitic anhydride and 15 g of dibutyl tin oxide, and the contents of the flask were reacted with each other at 230° C. under a nitrogen atmosphere while stirring until the softening point as measured according to ASTM D36-86 reached 120° C., thereby obtaining a polyester resin A. A glass transition point, a softening initiation temperature, a softening point and an acid value of the thus obtained polyester A are shown in Table 1. One kilogram of the obtained polyester A was placed on a sieve having an opening diameter of 5.6 mm according to JIS Z 8801 and shaken thereon. As a result, it was confirmed that no polyester remained on the sieve.

### Production Examples 2 to 5

### Production of Polyesters B to E

The same procedure as in Production Example 1 was repeated except that the amounts of the raw monomers used were varied according to the formulation as shown in Table 1, and then these monomers were reacted with each other until the softening point as measured according to ASTM D36-86 reached a desired temperature, thereby obtaining polyester B to E having properties as shown in Table 1. A glass transition point, a softening point, a softening initiation temperature and an acid value of each of the thus obtained polyesters are shown in Table 1. One kilogram of each of the obtained polyesters B to E was placed on a sieve having an opening diameter of 5.6 mm according to JIS Z 8801 and shaken thereon. As a result, it was confirmed that none of the polyesters remained on the sieve.

TABLE 1

| Polyesters | | | | |
|---|---|---|---|---|
| A | B | C | D | E |

Amounts of raw material charged (g)

| | | | | | |
|---|---|---|---|---|---|
| Bisphenol A-PO adduct | 1750 | 3374 | 2450 | 1225 | 525 |
| Bisphenol A-EO adduct | 1625 | 33 | 975 | 2113 | 1950 |
| Glycerol | 0 | 0 | 0 | 0 | 138 |
| Terephthalic acid | 945 | 672 | 913 | 1527 | 1552 |
| Dodecenylsuccinic | 134 | 0 | 938 | 0 | 0 |
| anhydride | | | | | |
| Fumaric acid | 0 | 696 | 0 | 0 | 0 |
| Trimellitic anhydride | 396 | 0 | 211 | 0 | 0 |
| Dibutyl tin oxide | 15 | 15 | 15 | 15 | 15 |

Trivalent or higher-valent monomer component

| | | | | | |
|---|---|---|---|---|---|
| Trivalent or higher-valent | 25 | 0 | 11 | 0 | 0 |
| monomer component in | | | | | |
| acid component (mol %) | | | | | |
| Trivalent or higher-valent | 0 | 0 | 0 | 0 | 16 |
| monomer component in | | | | | |
| alcohol component | | | | | |
| (mol %) | | | | | |
| Trivalent or higher-valent | 11 | 0 | 6 | 0 | 8 |
| monomer component in | | | | | |
| whole constituting | | | | | |
| monomer component | | | | | |
| (mol %) | | | | | |

Resin

| | | | | | |
|---|---|---|---|---|---|
| Acid value (mgKOH/g) | 21 | 24.4 | 11.8 | 5.0 | 21.4 |
| Softening initiation | 81.5 | 80.1 | 76.1 | 84.3 | 87.7 |
| temperature (° C.) | | | | | |
| Softening point (° C.) | 122.1 | 107.1 | 111.2 | 112.2 | 121.3 |
| Glass transition point | 64.5 | 65.4 | 54.8 | 63 | 72.7 |
| (° C.) | | | | | |

### Example 1

### Production of Resin Emulsion A

### (a) Mixing Step

Three hundred grams of the polyester A, 12 g of a nonionic surfactant “EMULGEN 150” (polyoxyethylene lauryl ether (EO added: 40 mol); cloud point: 100° C. or higher; HLB: 18.4) available from Kao Corporation, 9.23 g of an anionic surfactant “NEOPELEX G-65” (sodium dodecylbenzenesulfonate; solid content: 65% by weight; water content: 35% by weight) available from Kao Corporation, and 15 g of a copper phthalocyanine pigment “ECB-301” available from Dainichiseika Color & Chemicals Mtg. Co., Ltd., were melted at 150° C. in a 5 L stainless steel flask while stirring with a paddle-shaped stirrer at a rate of 150 r/min

### (b) Neutralizing Step

Next, the contents of the flask were stabilized at 95° C. as the temperature lower, by 10° C. or more, than a softening point of the polyester. Thereafter, while stirring the resulting mixture with a paddle-shaped stirrer at a rate of 150 r/min, 126 g of a potassium hydroxide aqueous solution (concentration: 5% by weight; an amount required for neutralizing 100% of the polyester A) was dropped into the mixture over 40 min. Successively, while stirring the resulting mixture with a paddle-shaped stirrer at a rate of 150 r/min, 580 g of deionized water was dropped to the mixture over 3 h. During the stirring, the temperature of the system was maintained at 95° C. Then, the obtained reaction mixture was passed through a wire mesh having a 200 mesh screen (mesh size: 105 μm) to obtain a resin emulsion A containing the polyester A. As a result, it was confirmed that the particles contained in the thus obtained resin emulsion had a volume-median particle size of 108 nm, a CV value of 34 and a solid concentration of 31% by weight, and no resin components remained on the wire mesh. Other properties of the obtained resin emulsion A are shown in Table 2.

### Examples 2 to 5

### Production of Resin Emulsions B to E

The same procedure as in Example 1 was repeated except that the amounts of the polyester, nonionic surfactant, anionic surfactant, copper phthalocyanine pigment, potassium hydroxide aqueous solution and deionized water used were changed as shown in Table 2, thereby obtaining resin emulsions B to E. As a result, it was confirmed that no resin components remained on the wire mesh. Various properties of the thus obtained resin emulsions B to E are shown in Table 2.

### Comparative Example 1

### Production of Resin Emulsion F

The same procedure as in Example 1 was repeated except that the amounts of the polyester, nonionic surfactant, anionic surfactant, potassium hydroxide aqueous solution and deionized water used were changed as shown in Table 2, thereby obtaining a resin emulsion F. Various properties of the thus obtained resin emulsion F are shown in Table 2.

### Comparative Example 2

### Production of Resin Emulsion G

The same procedure as in Example 1 was repeated except that the amounts of the polyester, nonionic surfactant, anionic surfactant, potassium hydroxide aqueous solution and deionized water used were changed as shown in Table 2, thereby attempting to obtain a resin emulsion G. However, no emulsion was produced. When the obtained reaction mixture was passed through a wire mesh having a 200 mesh screen (mesh size: 105 μm), a majority of the resin components remained on the wire mesh.

### Reference Production Example 1

### Production of Resin Emulsion H

The same procedure as in Example 1 was repeated except that the amounts of the polyester, nonionic surfactant, anionic surfactant, potassium hydroxide aqueous solution and deionized water used were changed as shown in Table 2, thereby obtaining a resin emulsion H. Various properties of the thus obtained resin emulsion H are shown in Table 2.

TABLE 2

| | Examples | | | |
|---|---|---|---|---|
| | 1 | 2 | 3 | 4 |
| Resin emulsion | A | B | C | D |

Amounts charged (g)

| | | | | |
|---|---|---|---|---|
| Polyester A | 300 | | 195 | 150 |
| Polyester B | | | 105 | |
| Polyester C | | 300 | | |
| Polyester D | | | | 150 |
| Polyester E | | | | |
| Nonionic surfactant | 12 | 12 | 12 | 9 |
| Anionic surfactant | 9.23 | 4.62 | 9.23 | 9.23 |
| Copper phthalocyanine | 15 | 15 | 15 | 15 |
| pigment | | | | |
| 5 wt % KOH aqueous solution | 126 | 112 | 140 | 69 |
| Water | 580 | 594 | 567 | 551 |
| Trivalent crosslinked monomer | 11 | 6 | 7 | 6 |
| component in resin (mol %) | | | | |

Content¹⁾

| | | | | |
|---|---|---|---|---|
| Nonionic surfactant | 4.0 | 4.0 | 4.0 | 3.0 |
| Anionic surfactant | 2.0 | 1.0 | 2.0 | 2.0 |
| Content ratio of anionic | 0.50 | 0.25 | 0.50 | 0.67 |
| surfactant/nonionic surfactant | | | | |

Emulsified resin particles

| | | | | |
|---|---|---|---|---|
| Volume-median particle size | 0.108 | 0.331 | 0.152 | 0.124 |
| (D₅₀) (μm) | | | | |
| CV value | 34 | 25 | 31 | 28 |
| Softening point (° C.) | 105.3 | 97.3 | 104.1 | 102.6 |
| Glass transition point (Tg) (° C.) | 52.1 | 50.3 | 55.6 | 50.0 |
| Weight-average molecular | 3.2 × 10⁴ | 2.0 × 10⁴ | 2.1 × 10⁴ | 2.0 × 10⁴ |
| weight | | | | |
| Content of component having a | 6.6 | 2.5 | 3.2 | 3.1 |
| molecular weight of not less | | | | |
| than 10⁵ and not more than 10⁶ | | | | |
| (area %) | | | | |

| | | Comparative | Comparative | Reference |
|---|---|---|---|---|
| | Example 5 | Example 1 | Example 2 | Example 1 |
| Resin emulsion | E | F | G | H |

Amounts charged (g)

| | | | | |
|---|---|---|---|---|
| Polyester A | | 300 | 300 | 105 |
| Polyester B | | | | 195 |
| Polyester C | | | | |
| Polyester D | | | | |
| Polyester E | 300 | | | |
| Nonionic surfactant | 12 | 30 | 9 | 3 |
| Anionic surfactant | 13.85 | 23.00 | 0 | 4.62 |
| Copper phthalocyanine | 15 | 15 | 15 | 15 |
| pigment | | | | |
| 5 wt % KOH aqueous | 125 | 126 | 126 | 138 |
| solution | | | | |
| Water | 581 | 580 | 580 | 569 |
| Trivalent crosslinked | 8 | 11 | 11 | 4 |
| monomer component in resin | | | | |
| (mol %) | | | | |

Content¹⁾

| | | | | |
|---|---|---|---|---|
| Nonionic surfactant | 4.0 | 10.0 | 3.0 | 1.0 |
| Anionic surfactant | 3.0 | 5.0 | 0.0 | 1.0 |
| Content ratio of anionic | 0.75 | 0.50 | 0 | 1.0 |
| surfactant/nonionic | | | | |
| surfactant | | | | |

Emulsified resin particles

| | | | | |
|---|---|---|---|---|
| Volume-median particle | 0.104 | 0.092 | — | 0.152 |
| size (D₅₀) (μm) | | | | |
| CV value | 32 | 20 | — | 26 |
| Softening point (° C.) | 113.3 | 92.5 | — | 102.8 |
| Glass transition point | 55.7 | 35.9 | — | 59.8 |
| (Tg) (° C.) | | | | |
| Weight-average | 2.1 × 10⁴ | 2.4 × 10⁴ | — | 1.8 × 10⁴ |
| molecular weight | | | | |
| Content of component | 3.4 | 5.2 | — | 1.1 |
| having a molecular weight of | | | | |
| not less than 10⁵ and not more than | | | | |
| 10⁶ (area %) | | | | |

Note
¹⁾Part(s) by weight of the respective surfactants on the basis of 100 parts by weight of the resin

### Example 6

### 1. Production of Toner Mother Particles

### (1) Aggregating Step

Two hundred grams of the resin emulsion A obtained in Example 1 and 52 g of deionized water were charged into a 2 L flask. Next, 146 g of a 0.6 mol/L ammonium sulfate aqueous solution was dropped into the flask at room temperature over 30 min while stirring with a paddle-shaped stirrer at a rate of 100 r/min. Thereafter, the resultant dispersion was heated at a temperature rise rate of 0.16° C./min while stirring to allow growth of aggregated particles. The dispersion was heated until reaching 52° C. at which the temperature was fixed, and then allowed to stand for 3 h. After thus forming the aggregated particles, a dilute solution prepared by diluting 4.2 g of a sodium polyoxyethylenedodecylethersulfate aqueous solution (solid content: 28% by weight) with 37 g of deionized water was added thereto.

### (2) Coalescing Step

Thirty minutes after adding the dilute solution to the aggregated particles obtained in the aggregating step (1), the resultant dispersion was heated to 80° C. at a rate of 0.16° C./min and maintained at 80° C. for 1 h from the time at which the temperature of the dispersion reached 80° C., and then the heating was stopped. The obtained dispersion was gradually cooled to room temperature, and then subjected to a suction filtration step, a washing step and a drying step to obtain toner mother particles.

### 2. Production of Toner

Next, a hydrophobic silica (“R972” commercially available from Nippon Aerogel Co., Ltd.; number-average particle size: 16 nm) was externally added to the toner mother particles in an amount of 1.0 part by weight on the basis of 100 parts by weight of the toner mother particles using a Henschel mixer to obtain a cyan toner. The obtained toner had a volume-median particle size (D₅₀) of 4.7 μm. The heat-resistant storage property of the obtained toner was evaluated by the above-mentioned method. The results are shown in Table 3.

### Examples 7 to 10 and Comparative Example 3

The same procedure as in Example 6 was repeated except that the resin emulsion used was changed as shown in Table 3, thereby obtaining toner mother particles and then obtaining a toner therefrom. The thus obtained toner was subjected to evaluation of a heat-resistant storage property thereof by the same method as described above. The evaluation results of the toner are shown together with a volume-median particle size (D₅₀) thereof in Table 3.

### Example 11

### 1. Production of Toner Mother Particles

### (1-1) Aggregating Step

Two hundred grams of the resin emulsion A and 52 g of deionized water were charged into a 2 L flask. Next, 146 g of a 0.6 mol/L ammonium sulfate aqueous solution was dropped into the flask at room temperature over 30 min while stirring with a paddle-shaped stirrer at a rate of 100 r/min. Thereafter, the resultant dispersion was heated at a temperature rise rate of 0.16° C./min while stirring to form aggregated particles. The resulting dispersion was heated until reaching 55° C. at which the temperature was fixed, and then allowed to stand for 2 h, thereby obtaining aggregated particles.

### (1-2) Step of Adding Finer Emulsified Resin Particles

While maintaining the aggregated particles obtained in the above step (1-1) at a temperature of 55° C., a mixed solution containing 200 g of the resin emulsion H and 52 g of deionized water was dropped thereto at a rate of 1 g/min Thirty minutes after completion of the dropping, a dilute solution prepared by diluting 4.2 g of a sodium polyoxyethylenedodecylethersulfate aqueous solution (solid content: 28% by weight) with 37 g of deionized water was added thereto.

### (2) Coalescing Step

Thirty minutes after adding the dilute solution, the resultant dispersion was heated to 80° C. at a rate of 0.16° C./min and maintained at 80° C. for 1 h from the time at which the temperature of the dispersion reached 80° C., and then the heating was stopped.

The obtained dispersion was gradually cooled to room temperature, and then subjected to a suction filtration step, a washing step and a drying step to obtain toner mother particles.

### 2. Production of Toner

Next, a hydrophobic silica (“R972” commercially available from Nippon Aerogel Co., Ltd.; number-average particle size: 16 nm) was externally added to the toner mother particles in an amount of 1.0 part by weight on the basis of 100 parts by weight of the toner mother particles using a Henschel mixer to obtain a cyan toner. The obtained toner had a volume-median particle size (D₅₀) of 5.0 μm. The heat-resistant storage property of the obtained toner was evaluated by the above-mentioned method. The results are shown in Table 3.

TABLE 3

| | Resin emulsion | | |
|---|---|---|---|
| | used for | Volume-median | Heat-resistant |
| | production of | particle size (D₅₀) | storage property |
| | toner | of toner (μm) | of toner |
| Example 6 | A | 4.7 | A |
| Example 7 | B | 4.9 | B |
| Example 8 | C | 4.6 | A |
| Example 9 | D | 4.8 | B |
| Example 10 | E | 4.6 | A |
| Example 11 | A + H | 5.0 | A |
| Comparative | F | 5.0 | C |
| Example 3 | | | |

### INDUSTRIAL APPLICABILITY

The resin emulsion of the present invention exhibits a good emulsification performance and is capable of producing a toner having an excellent heat-resistant storage property, and therefore can be suitably used for production of a toner for electrophotography which is employed in electrophotographic method, electrostatic recording method, electrostatic printing method, etc.

1. A process for producing a resin emulsion, comprising:
(a) mixing a resin comprising a polyester having a constitutional unit derived from at least one component selected from the group consisting of a trivalent or higher-valent alcohol component and a trivalent or higher-valent carboxylic acid component, an anionic surfactant, and a nonionic surfactant with each other at a temperature which is not lower than a temperature lower by 10° C. than a softening point of the resin, the nonionic surfactant being used in an amount of more than 1.0 part by weight and less than 5 parts by weight on the basis of 100 parts by weight of the resin; and
(b) neutralizing the resulting mixture obtained in (a) with a basic compound in an aqueous medium at a temperature not higher than the softening point of the resin.

2. The process according to claim 1, wherein the anionic surfactant is used in an amount of not less than 0.1 part by weight and less than 5 parts by weight on the basis of 100 parts by weight of the binder resin.

3. The process according to claim 1, wherein a weight ratio of the anionic surfactant to the nonionic surfactant (anionic surfactant/nonionic surfactant) used in the resin emulsion is from 0.2 to 0.9.

4. The process according to claim 1, wherein the at least one component selected from the group consisting of a trivalent or higher-valent alcohol component and a trivalent or higher-valent carboxylic acid component comprises at least one component selected from the group consisting of a trivalent alcohol component and a trivalent carboxylic acid component.

5. The process according to claim 1, wherein a total content of the constitutional unit derived from at least one component selected from the group consisting of a trivalent or higher-valent alcohol component and a trivalent or higher-valent carboxylic acid component in the polyester is from 4 to 25 mol %.

6. A resin emulsion produced by the process according to claim 1.

7. A resin emulsion comprising a binder resin comprising a polyester having a constitutional unit derived from at least one component selected from the group consisting of a trivalent or higher-valent alcohol component and a trivalent or higher-valent carboxylic acid component, a nonionic surfactant, and an anionic surfactant, wherein the binder resin is contained in the form of resin particles having a weight-average molecular weight of from 2×10⁴ to 1×10⁵ and comprising a component having a molecular weight of not less than 1×10⁵ and not more than 1×10⁶ in an amount of from 2 to 15%, and a content of the nonionic surfactant in the resin emulsion is more than 1.0 part by weight and less than 5 parts by weight on the basis of 100 parts by weight of the binder resin.

8. The resin emulsion according to claim 7, wherein a total content of the constitutional unit derived from at least one component selected from the group consisting of a trivalent or higher-valent alcohol component and a trivalent or higher-valent carboxylic acid component in the polyester is from 4 to 25 mol %.

9. A resin emulsion produced by emulsifying a binder resin comprising a polyester having a constitutional unit derived from at least one component selected from the group consisting of a trivalent or higher-valent alcohol component and a trivalent or higher-valent carboxylic acid component, in an aqueous medium in the presence of a nonionic surfactant and an anionic surfactant, wherein the binder resin is contained in the form of resin particles having a weight-average molecular weight of from 2×10⁴ to 1×10⁵ and comprising a component having a molecular weight of not less than 1×10⁵ and not more than 1×10⁶ in an amount of from 2 to 15%, and a content of the nonionic surfactant in the resin emulsion is more than 1.0 part by weight and less than 5 parts by weight on the basis of 100 parts by weight of the binder resin.

10. A process for producing a toner for electrophotography, comprising:
(1) producing a resin emulsion by the process according to claim 1; and
(2) aggregating and coalescing emulsified resin particles contained in the resin emulsion obtained in (1).

11. The process according to claim 9, wherein upon aggregation in (2), finer emulsified resin particles are added to the emulsified resin particles contained in the resin emulsion obtained in (1).

12. A toner for electrophotography produced according to claim 10.

13-15. (canceled)

16. The process according to claim 10, wherein a volume median particle size (D₅₀) of the aggregated particles is in a range of 1 to 10 μm.

17. The process according to claim 10, comprising carrying out said aggregating in a ph value in a range of 2 to 10.
